(19) United States
(12) Patent Application Publication
(10) Pub. No.: US 2011/0069722 A1
(43) Pub. Date: Mar. 24, 2011

(54) SWEPT FIBER LASER SOURCE FOR OPTICAL COHERENCE TOMOGRAPHY

(76) Inventors: Antonio B. Lobo Ribeiro, Maia (PT); Irina Trifanov, Maia (PT); Liviu Neagu, Bucharest (RO)

(21) Appl. No.: 12/565,704

(22) Filed: Sep. 23, 2009

(51) Int. Cl. H01S 3/30

(52) U.S. Cl. 372/6

(57) ABSTRACT

The present invention provides a swept fiber optic laser source for optical coherence tomography emitting around ˜1060 nm wavelength, with tuning range higher than 50 nm, sweep repetition rate from DC to 40 kHz, instantaneous linewidth shorter than 50 pm (FWHM), and providing an average output around 1 mW (or 20 mW with output optical booster amplifier). The fiber laser source is based on a proper linear-cavity fiber laser configuration, with an intra-cavity half-symmetrical confocal Fabry-Perot tunable fiber (FP-TFF) filter and semiconductor optical amplifier (SOA), a device combination that gives a very robust and vibration-resistant laser configuration.

### BACKGROUND OF THE INVENTION

1. Field of Invention

This invention relates to optical coherence tomography and more specifically, to a swept fiber optic laser source centered near a wavelength of 1060 nm with a tuning range higher than 50 nm, a sweep repetition rate from DC to 40 kHz, an instantaneous line-width shorter than 40 pm (FWHM), and providing an average output power around 1 mW (or 20 mW with an output optical booster amplifier).

2. Description of Related Art

Commercially available retinal ophthalmic optical coherence tomography (OCT) systems operate at a central wavelength of approximately 820 nm due to the relatively low cumulated absorption of the eye tissue at this wavelength. Although the majority of retina imaging reports refer to this band, and ultrahigh resolution has also been demonstrated in this wavelength region for resolving intra-retinal layers, it has limited depth penetration beyond retinal pigment epithelium (RPE). For imaging features beyond the RPE, longer wavelengths are more suitable. See Unterhuber et al., “In vivo retinal optical coherence tomography at 1040 nm-enhanced penetration into the choroids,” Optics Express 13(9), pp. 3252-3258 (2005), the disclosure of which is incorporated by reference herein in its entirety. This relates to the fact that the absorption and scattering properties of melanin (the main chromophore in the RPE) tend to decrease with increasing wavelength.

Water absorption, on the other hand, represents a more critical limitation especially when imaging a biological sample because of its high content (˜90%) of water. There is, however, a spectral window restricted to a wavelength span of 100 nm (a band from 1 μm-1.1 μm) where the water absorption spectrum exhibits a minimum value. Moreover, the optical power loss due to increased water absorption compared to the 800 nm band is compensated by the fact that the corneal maximum permissible exposure for longer wavelengths also increases according to American National Standards Institute (ANSI) and International Electrotechnical Commission (IEC) standards. An additional advantage of optical imaging at 1060 nm wavelength band is the zero dispersion point of water, which eliminates the depth dependent broadening of axial resolution over reasonable depth penetration. See Pova\check{z}ay et al., “Enhanced visualization of choroidal vessels using ultrahigh resolution ophthalmic OCT at 1050 nm,” Optics Express 11, pp. 1980-1986 (2003), the disclosure of which is incorporated by reference herein in its entirety.

Commercial OCT systems traditionally use 850 nm broadband light sources providing a wide range of emission wavelengths, all simultaneously. The OCT systems that use 1050 nm broadband light sources need an expensive InGaAs linear camera for photodetection, which greatly increases the overall cost of the unit. With a wavelength swept source, interference signals at individual wavelengths can be measured sequentially with high spectral resolution and with an inexpensive InGaAs photodetector. This method offers significantly higher sensitivity than the traditional time-domain used in conventional OCT systems with broadband sources.

### SUMMARY OF THE INVENTION

The present invention overcomes these and other deficiencies of the prior art by providing a swept fiber optic laser source emitting around ˜1060 nm wavelength, with tuning range higher than 50 nm, sweep repetition rate from DC to 40 kHz, instantaneous linewidth shorter than 50 pm (FWHM), and providing an average output around 1 mW (or 20 mW with output optical booster amplifier). The fiber laser source is based on a proper linear-cavity fiber laser configuration, with an intra-cavity half-symmetrical confocal Fabry-Perot tunable fiber (FP-TFF) filter and semiconductor optical amplifier (SOA)—a device combination that gives a very robust and vibration-resistant laser configuration.

In an embodiment of the invention, a swept fiber laser source comprises: an optical amplifier, a mirror optically coupled to a fiber end of the optical amplifier, an optical circulator optically coupled to another fiber end of the optical amplifier, a tunable fiber filter optically coupled to the optical circulator, and a fiber coupler comprising a first input port and a second input port, the first input port being optically coupled to the optical circulator and the second input port being optically coupled to the tunable fiber filter. The optical amplifier comprises a semiconductor optical amplifier. The swept fiber laser source may further comprise a fiber pigtailed polarizer element located between the tunable fiber filter and the fiber coupler. The tunable fiber filter may comprise an intra-cavity half-symmetrical confocal Fabry-Perot tunable fiber (FP-TFF) filter or a multi-inference filter selected from the group consisting of: a fiber Bragg grating, a flat fiber Fabry-Perot filter, an acousto-optic tunable filter, a microelectromechanical system (MEMS) tilt filter, and a combination thereof. The source has an adjustable output wavelength between 1010 nm and 1110 nm, a linewidth less than 50 pm at full width half maximum, and an output power of 1 mW. The swept fiber laser source may further comprise an optical amplifier booster stage optically coupled to an output port of the fiber coupler to boost the output power to 20 mW. The optical amplifier may also comprise an optical fiber gain media section including a single mode Yb-doped fiber optically coupled at one end to the mirror, a second fiber coupler optically having a first input port, second input port, and an output port, the first input port being optically coupled to the single mode Yb-doped fiber and the output port being optically coupled to the optical circulator, and a pump source optically coupled to the second input port of the second fiber coupler. The pump source comprising a laser diode at 975 nm The coupler has a 30/70 coupling ratio between the first input port and the second input port, respectively. The optical circulator may comprises a polarization maintaining isolator, which includes a blocking arm to eliminate a polarization. The swept fiber laser source may be implemented in an optical coherence imaging system.

In another embodiment of the invention, a swept fiber laser source comprises: an optical fiber gain media, a mirror optically coupled to the optical fiber gain media, an optical circulator optically coupled to the optical fiber gain media, a tunable fiber filter optically coupled to the optical circulator, and a fiber coupler comprising a first input port and a second input port, the first input port being optically coupled to the optical circulator and the second input port being optically coupled to the tunable fiber filter. The optical fiber gain media comprises: a single mode Yb-doped fiber, a pump coupler, and a pump source. The single mode Yb-doped fiber has a peak absorption coefficient of 250 db/m at 975 nm and a length greater than 8 meters. The pump source comprises a pump laser diode emitting light at 975 nm.

Compared with laser ring cavity lasers, linear cavity lasers have the advantage that the gain medium amplifies the laser light twice per circulation, thus making it easy to reach deep saturation. Therefore, large tuning ranges as well as a low threshold pump power and high slope efficiency can be easily achieved.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 illustrates a swept fiber laser source according to an embodiment of the invention;

FIG. 2 illustrates a swept fiber laser source comprising a booster stage according to an embodiment of the invention;

FIG. 3 illustrates a plot of continuous wave (CW) emission spectra of the swept fiber laser source of FIG. 1;

FIG. 4 shows three plots of the sweeping optical spectra as a function of sweeping rate according to an embodiment of the invention;

FIG. 5 shows a plot comparison of the continuous wave (CW) emission spectra of the swept fiber laser source with and without an optical amplifier booster;

FIG. 6 shows the wavelength tuning range curve of the swept fiber laser according to an embodiment of the invention; and

FIG. 7 illustrates a swept fiber laser source according to an embodiment of the invention.

### DETAILED DESCRIPTION OF EMBODIMENTS

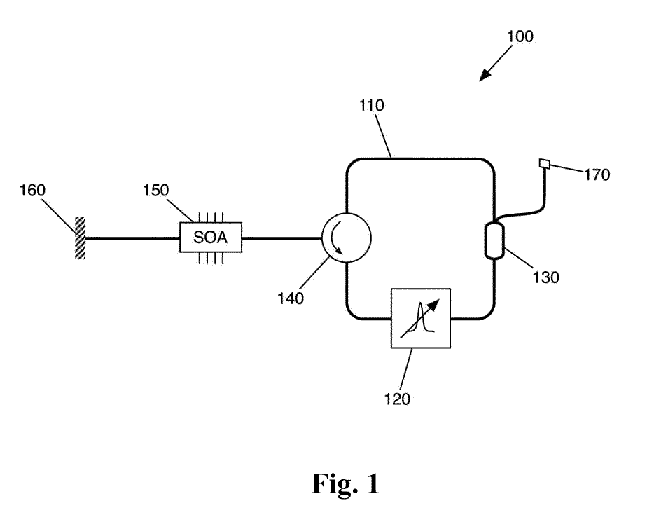

Further features and advantages of the invention, as well as the structure and operation of various embodiments of the invention, are described in detail below with reference to the accompanying FIGS. 1-7, wherein like reference numerals refer to like elements. Although the fiber source is described in the context of optical coherence tomography, one of ordinary skill in the art readily appreciates that the present invention can be implemented in any type of system where it is desired to implement a swept fiber laser source with a wavelength emission centered near 1060 nm, for example, optical sensing (strain and temperature).

FIG. 1 illustrates a swept fiber laser source 100 according to an embodiment of the invention. The swept fiber laser source 100 comprises a semiconductor optical amplifier (SOA) device 150 spliced at one fiber end to a common-port of a polarization-maintaining (PM) optical circulator 140. The other fiber end of the SOA device 150 is spliced to a PM fiber mirror 160. The input port of the PM optical circulator 140 is connected to a PM single mode fiber 110, which is also connected to one port of an output of a PM fiber coupler 130 with a tailored coupling ratio, such as a 30/70 ratio (other coupling ratio values such as, but not limited to 50/50, 20/80, 10/90 can also be used in order to adjust the overall optical power of the swept fiber laser source 100). The output port of this output PM fiber coupler 130 is spliced to a PM fiber connector 170, such as a ferrule connector with an angled physical contact (FC/APC) or fiber connector angle (FCA). The second input port of the output PM fiber coupler 130, is connected to the output-port of a PM tunable fiber filter 120, which may comprise an intra-cavity half-symmetrical confocal Fabry-Perot tunable fiber (FP-TFF) filter. However, one of ordinary skill in the art readily appreciates that other tunable multi-inference fiber filters, such as, but not limited to a fiber Bragg grating, a flat fiber Fabry-Perot filter, an acousto-optic tunable filter, a microelectromechanical system (MEMS) tilt filter, or a combination thereof can be implemented in place of the FP-TFF filter.

Fibers in the present invention preferably comprise polarization-maintaining (PM) single mode silica fiber such as Nufern PM 980 fiber. In another embodiment of the invention, non-PM single mode fibers may be implemented, but the stability of the optical output of the fiber laser 100 may drift, imposing the need to control the polarization state of the light through the laser cavity. Specifically, the round-trip cavity eigenmodes will split into two orthogonal elliptically polarized modes. These modes will settle in polarization directions and states depending on local stress axes in the fiber or in any of the fiber pigtailed elements. Hence, the polarization axis of the circulating light is expected to stay stable, but may wonder depending on various factors such as thermal or internal stress factors. Their axis of orientation would appear to be arbitrary, but will depend on the orientation of local stress factors in the mirrors, SOA or couplers.

In an embodiment of the invention, the SOA device 150 features a small signal gain peak of 27.5 dB at 1060 nm. Small signal refers to the condition where the input power is low, population inversion is high, and gain is still at max or close to max, such as when the input power is a few microwatts. Two advantages of using a SOA device 150 as a gain media are: (1) high gain (typically 20 to 35 dB) with a broad spectral bandwidth, and (2) the gain response time of a SOA is about 250 ps, much shorter than the micro- or millisecond timescale of other gain media such as Ti:Sapphire and rare-earth doped fibers. For a fast sweep operation, the short gain response time is highly desirable to minimize the intensity noise of the laser output.

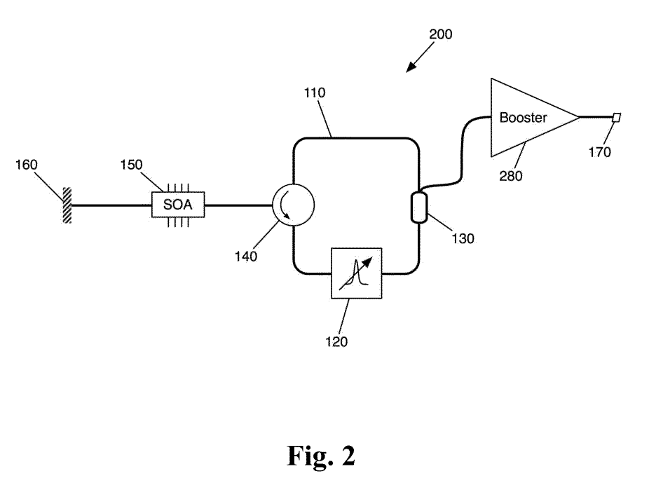

FIG. 2 illustrates a swept fiber laser source 200 including a booster stage according to an embodiment of the invention. Particularly, swept fiber laser source 200 comprises an optical amplifier booster stage 280 disposed between before the PM fiber connector 170, such as a ferrule connector with angled physical contact (FC/APC) or fiber connector angle (FCA). In an exemplary embodiment of the invention, the optical amplifier booster stage 280 comprises an Yb-doped fiber amplifier booster. In another embodiment of the invention, the optical amplifier booster stage 280 comprises a semiconductor optical amplifier (SOA) booster, which is relatively smaller and more compact than a fiber amplifier. A booster amplifier operates in the saturated-gain regime and has a gain range from 3 to 10 dB, which is lower than those operating in small signal.

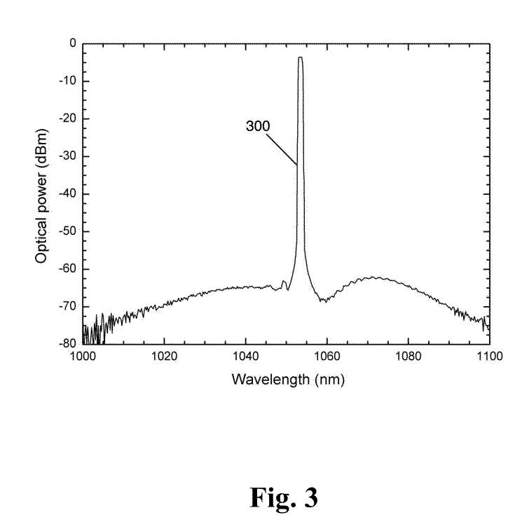

FIG. 3 illustrates a plot of continuous wave (CW) emission spectra 300 of the swept fiber laser source of the present invention without a booster amplifier. This emission spectra 300 is centered around 1055 nm and has a full width at half maximum (FWHM) less than 50 pm, emitting an average optical power around 1 mW and having a side-mode suppression ratio (SMSR) better than 55 dB. The amplified spontaneous emission (ASE) noise is very small because the PM tunable fiber filter 120 is placed before the output PM fiber coupler 130 as shown in FIG. 1. The CW emitted center wavelength of this swept fiber laser source is tunable (with a range higher than 50 nm) and is controlled by the amplitude of the DC voltage applied to the PM tunable fiber filter 120.

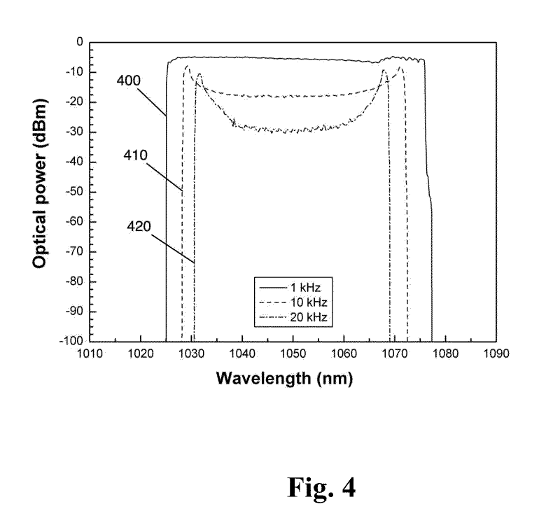

FIG. 4 shows three normalized plots 400, 410, and 420 of the sweeping optical spectra of the present invention without a booster amplifier obtained from an optical spectrum analyzer. Specifically, the spectrum analyzer operated in peak-hold mode with 1 nm resolution. The plot 400 represents a sweep repetition rate of 1 kHz for the fiber laser. The plots 410 and 420 represent a sweep repetition rate of 10 kHz and 20 kHz, respectively. The present swept fiber laser source is capable of sweeping repetition rates up to 40 kHz, but with some optical power reduction as seen in FIG. 4, between the traces 400, 410 and 420. Here, one of ordinary skill in the art can appreciate the relatively large tuning range, which is attractive for many applications including OCT.

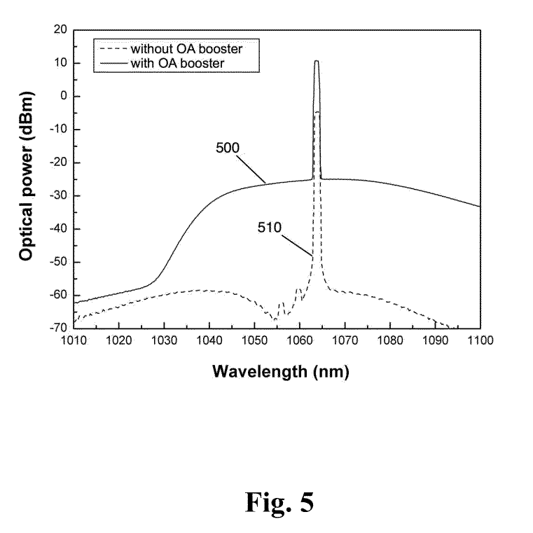

FIG. 5 shows a plot comparison of the continuous wave (CW) emission spectra of the swept fiber laser source with and without optical amplifier booster 280. Specifically, plot 500 represents the swept fiber laser source 200 with the presence of the optical amplifier booster 280. The plot 510 represents the swept fiber laser source 100 (without the presence of the booster 280. Due to the amplified spontaneous emission (ASE) noise of the optical amplifier booster 280, the SMSR of the amplified output signal 500 will be reduced (being lower than 40 dB), but the output power is higher, reaching values around 20 mW and still maintaining the FWHM linewidth of the swept fiber laser of the present invention. As shown, the plot 510 was generated at 1065 nm This shift is not critical and simply indicates that a different voltage was applied at the time to the tuning device, or that the tuning device has drifted in wavelength.

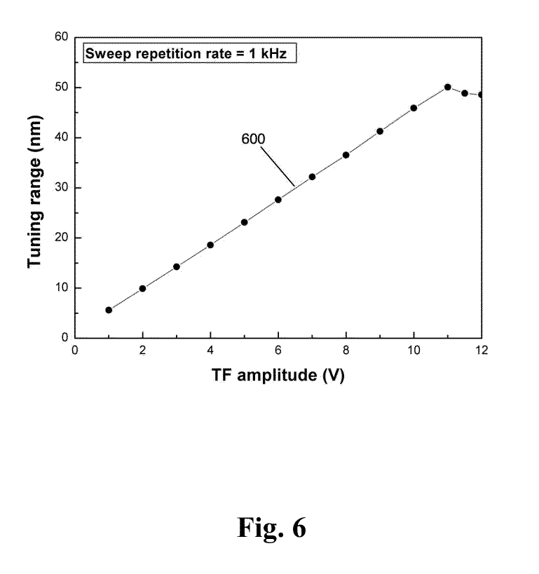

FIG. 6 shows the wavelength tuning range curve 600 of the swept fiber laser according to an embodiment of the invention. The tuning range curve 600 is a function of the amplitude of the swept signal applied (sinusoidal signal at 1 kHz) to the tunable fiber filter. This results show that the swept fiber laser has good bidirectional linearity with a tuning coefficient of about 5.2 nm/V.

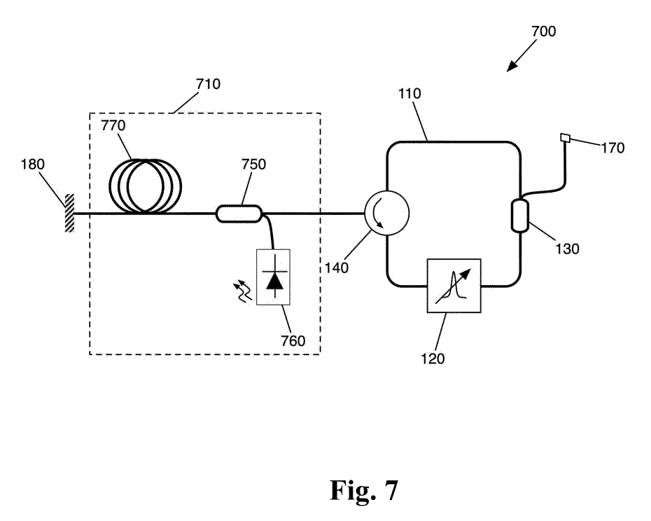

FIG. 7 illustrates a swept fiber laser source 700 according to an embodiment of the invention. The swept fiber laser source 700 comprises an optical fiber gain media section 710 instead of the SOA gain media 150, which was implemented in the fiber laser source 100. The gain media section 710 comprises a PM single mode Yb-doped fiber 770 as a gain media combined with a PM pump fiber coupler 750 and pump source 760. The PM single mode Yd-doped fiber 770 has a peak absorption coefficient of 250 dB/m at 975 nm band and measures 8-10 m in length. One end of this PM single mode Yb-doped fiber is spliced to a PM pump fiber coupler 750, such as a 975/1060 thin-film or fused fiber coupler, and the other end is spliced to the PM fiber minor 160. The pump source 760 comprises a pump laser diode at 975 nm single mode or multimode, and emits a pump signal that is coupled in the input fiber port of the 975/1060 pump coupler 750, and propagates into the PM single mode Yb-doped fiber 770, where it is absorbed by and excites the ytterbium dopant ions in the fiber core to reach an electronic population inversion that will able to amplify the optical energy.

The configuration of the swept fiber laser source 100 is ideal and designed to produce very good performance. However, one can produce a similarly tunable laser, but with slightly diminished extinction ratio and more noise if one were to introduce some simplifications to the components. For example, according to an embodiment of the invention, the components of the fiber laser source 100 are non-PM. This simplifies and reduces the cost of many of the components. In another embodiment of the invention, the circulator 140 comprises one or more polarization maintaining isolators. To introduce polarization selection and blocking, one of these isolators, preferably the one associated with the fiber arm that is connected to the filter element 120, contains a blocking arm to eliminate one of the two polarizations. This polarization loss factor, would force the system to operate at the unattenuated polarization, and with almost the same power and SNR. In another embodiment of the invention, the circulator 140 is a non-PM circulator and a fiber pigtailed polarizer element is introduced anywhere in the FIG. 1, but preferably between the PM tunable fiber filter 120 and the output PM fiber coupler 130. The preferred polarization axis for this element would be adjusted (aligned) to align the output polarization to the desired axis at the PM fiber connector 170. This location would produce the best SNR and polarization extinction signal at the PM fiber connector 170. In another embodiment of the invention, no polarization selection or discrimination is introduced. The output signal at the fiber connector 170 therefore does not have a well defined polarization axis. Nevertheless, the output signal is polarized in some random polarization state. Its wavelength however is still widely tunable and selectable by the tunable fiber filter 120.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A swept fiber laser source comprising:
an optical amplifier,
a mirror optically coupled to a fiber end of the optical amplifier,
an optical circulator optically coupled to another fiber end of the optical amplifier,
a tunable fiber filter optically coupled to the optical circulator, and
a fiber coupler comprising a first input port and a second input port, the first input port being optically coupled to the optical circulator and the second input port being optically coupled to the tunable fiber filter.

2. The swept fiber laser source of claim 1, the optical amplifier comprises a semiconductor optical amplifier.

3. The swept fiber laser source of claim 1, the mirror and optical circulator are a polarization-maintaining mirror and polarization optical circulator, respectively.

4. The swept fiber laser source of claim 1, the mirror and optical circulator are a non-polarization-maintaining mirror and polarization optical circulator, respectively.

5. The swept fiber laser source of claim 4, further comprising a fiber pigtailed polarizer element.

6. The swept fiber laser source of claim 5, the fiber pigtailed polarizer element is located between the tunable fiber filter and the fiber coupler.

7. The swept fiber laser source of claim 1, the tunable fiber filter comprises an intra-cavity half-symmetrical confocal Fabry-Perot tunable fiber (FP-TEE) filter.

8. The swept fiber laser source of claim 1, the tunable fiber filter comprises a multi-inference filter selected from the group consisting of: a fiber Bragg grating, a flat fiber Fabry-Perot filter, an acousto-optic tunable filter, a microelectromechanical system (MEMS) tilt filter, and a combination thereof.

9. The swept fiber laser source of claim 1, the source having an adjustable output wavelength between 1010 nm and 1110 nm, and a linewidth less than 50 pm at full width half maximum.

10. The swept fiber laser source of claim 9, the source having an output power of 1 mW.

11. The swept fiber laser source of claim 1, further comprising an optical amplifier booster stage optically coupled to an output port of the fiber coupler.

12. The swept fiber laser source of claim 11, the source having an output power of 20 mW.

13. The swept fiber laser source of claim 1, the optical amplifier comprising an optical fiber gain media section.

14. The swept fiber laser source of claim 13, the optical fiber gain media section comprising:
a single mode Yb-doped fiber optically coupled at one end to the mirror,
a second fiber coupler optically having a first input port, second input port, and an output port, the first input port being optically coupled to the single mode Yb-doped fiber and the output port being optically coupled to the optical circulator, and
a pump source optically coupled to the second input port of the second fiber coupler.

15. The swept fiber laser source of claim 14, the pump source comprising a laser diode at 975 nm.

16. The swept fiber laser source of claim 1, the coupler having a 30/70 coupling ratio between the first input port and the second input port, respectively.

17. The swept fiber laser source of claim 1, the optical circulator comprising a polarization maintaining isolator, which comprises a blocking arm to eliminate a polarization.

18. An optical coherence imaging system comprising the swept fiber laser source of claim 1.

19. A swept fiber laser source comprising:
an optical fiber gain media,
a mirror optically coupled to the optical fiber gain media,
an optical circulator optically coupled to the optical fiber gain media,
a tunable fiber filter optically coupled to the optical circulator, and
a fiber coupler comprising a first input port and a second input port, the first input port being optically coupled to the optical circulator and the second input port being optically coupled to the tunable fiber filter.

20. The swept fiber laser source of claim 19, the optical fiber gain media comprising:
a single mode Yb-doped fiber,
a pump coupler, and
a pump source.

21. The swept fiber laser source of claim 20, the single mode Yb-doped fiber having a peak absorption coefficient of 250 db/m at 975 nm.

22. The swept fiber laser source of claim 20, the single mode Yb-doped fiber having a length greater than 8 meters.

23. The swept fiber laser source of claim 20, the pump source comprising a pump laser diode emitting light at 975 nm.
